(19) United States
(12) Patent Application Publication
(10) Pub. No.: US 2003/0136155 A1
(43) Pub. Date: Jul. 24, 2003

(54) Fixing carrier for manufacturing a coupler for optical fibers

(76) Inventor: Ting-An Wang, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/119,460

(22) Filed: Apr. 10, 2002

(30) Foreign Application Priority Data
Jan. 23, 2002 (TW) 091200618

(51) Int. Cl. G02B 6/255

(52) U.S. Cl. 65/501

(57) ABSTRACT

A fixing carrier for manufacturing a coupler for optical fibers. The fixing carrier has a plate. Two reels for rolling optical fibers are detachably mounted at two ends of the plate respectively. Two clamps for fastening optical fibers are mounted on the plate and adjacent the reels respectively. A plurality of seats is mounted on the plate and adjacent the reels respectively. A plurality of optical fiber adapters is mounted in the seats respectively.

### BACKGROUND OF THE INVENTION

1. Field of the Invention

The present invention is related to a tool used for manufacturing a coupler for optical fibers, and more particularly to a fixing carrier for securing optical fibers during processing.

2. Description of Related Art

A coupler for optical fibers, as a component of optical communication, is manufactured by means of a technology called “fused biconical taper”. The processes of manufacturing a coupler include sintering, sleeve-encapsulating, tube-encapsulating, testing, packing etc.

In processing, workers need to manually cut off optical fibers with a predetermined length and strip off sheathes of the optical fibers for further processing the optical fibers. Because of this manual treatment for optical fibers, the workers for sintering, sleeve-encapsulating or tube-encapsulating must stop machines and these processes are incontinuous. Therefore, efficiency of the machines and productivity of the coupler are very low.

Therefore, the invention provides a fixing carrier for pre-treating optical fibers to mitigate and/or obviate the aforementioned problems.

### SUMMARY OF THE INVENTION

The main objective of the invention is to provide a fixing carrier for manufacturing a coupler for optical fibers, which can improve efficiency of machines and productivity of a coupler.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a fixing carrier in accordance with the invention;

FIG. 2 is an exploded perspective view of a reel of the fixing carrier in accordance with the invention;

FIG. 3 is a top view showing that optical fibers are fastened on the fixing carrier;

FIG. 4 is a schematic view showing that the fixing carrier is mounted on a work table; and

FIG. 5 is a schematic view of a manufacturing process of a coupler for optical fibers in accordance with the invention.

### DETAILED DESCRIPTION OF THE PREFERRED EMBODIMENT

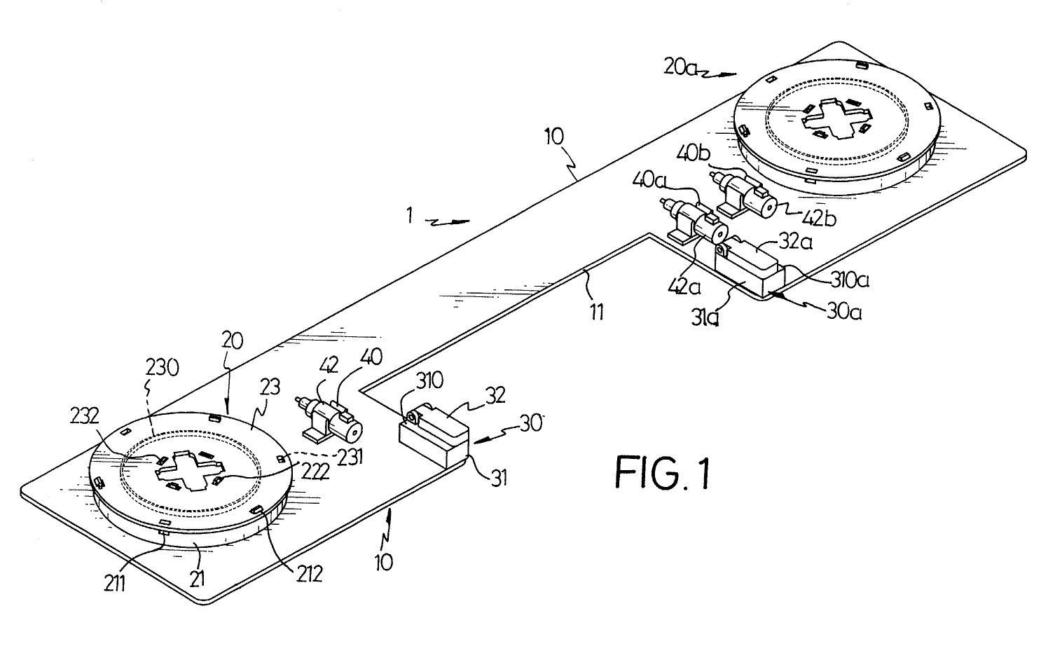

Referring to FIG. 1, a fixing carrier (1) for manufacturing a coupler of optical fibers is composed of a plate (10), two reels (20, 20a), two clamps (30, 30a), a plurality of seats (40, 40a, 40b), and a plurality of optical fiber adapters (42, 42a, 42b) respectively fastened in the seats (40, 40a, 40b).

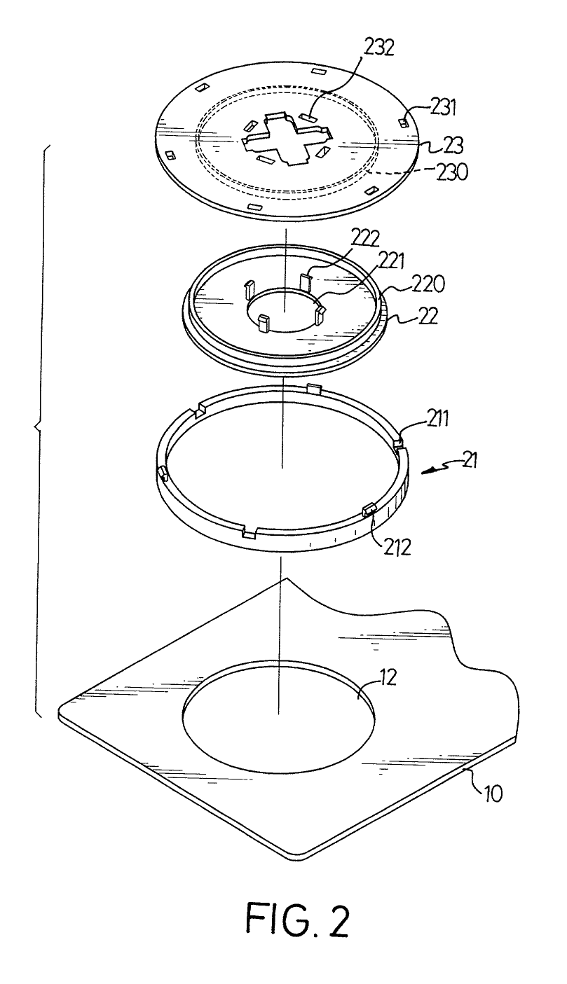

The plate (10) viewed from the top as an inversed U-shape, has an opening (11) defined at a central portion thereof. The reels (20, 20a) are rotatably provided on two sides of the plate (10) respectively. Referring to FIG. 2, the first reel (20) is mounted at a left side of the plate (10) in which a hole (12) is defined in alignment with the first reel (20).

The reel (20) is composed of a bottom ring (21), an inner disk (22), and an upper cover (23). The bottom ring (21) has a plurality of notches (211) and protrusions (212) alternately and evenly formed on an upper edge thereof. In this embodiment, there are three notches (211) and three protrusions (212) on the bottom ring (21). The inner disk (22), of which an outer diameter is larger than a diameter of the hole (12), has an inner ring (220) adjacent an outer edge thereof and extending in the hole (12) from a bottom of the plate (10). An aperture (221) is defined through a central portion of the inner ring (220) and a plurality of barbs (222) is defined around the aperture (221) and extends upwards. A height of the bottom ring (21) is larger than a height of the inner ring (220). The upper cover (23), of which an outer diameter is larger than that of the bottom ring (21), has an upper ring (230) formed at a bottom face thereof. The upper ring (230), of which an outer diameter is slightly smaller an inner diameter of the inner ring (220), is received in the inner ring (220). The upper cover (23) has a plurality of first slots (231) circumferentially defined adjacent an outer edge thereof for receiving the protrusions (212) in the first slots (231) respectively. A plurality of second slots (232) is defined at a central portion of the upper cover (23) for receiving the barbs (222) of the inner disk (22).

In assembling of the reel (20), the inner disk (22) is inserted through the hole (12) from the bottom of the plate (10) to receive the inner ring (220) in the hole (12). The bottom ring (21) is provided on the plate (10) and aligned with the hole (12). The upper ring (230) of the upper cover is received in the inner ring (220) of the inner disk (22), and the barbs (222) are respectively engaged in the second slots (232). Thereafter, the protrusions (212) are engaged in the first slots (231) respectively.

Although the first reel (20) is illustrated in FIG. 2, it should be known by those skilled in the art that the second reel (20a) has the same structures and components.

Referring back to FIG. 1, the clamps (20, 20a) are respectively provided at two edges of the plate (10) adjacent the opening (11). The clamps (20, 20a) each have a base (31, 31a) secured on the plate (10) and a clamping sheet (32, 32a) pivotally mounted on an upper surface (310) of the base (31, 31a).

In this embodiment, there are three seats (40, 40a, 40b) provided on the plate (10), wherein the first seat (40) is mounted adjacent the first reel (20), and the second and third seats (40a, 40b) are mounted adjacent the second reel (20a). Three optical fiber adapters (42, 42a, 42b) are respectively mounted on the seats (40, 40a, 40b).

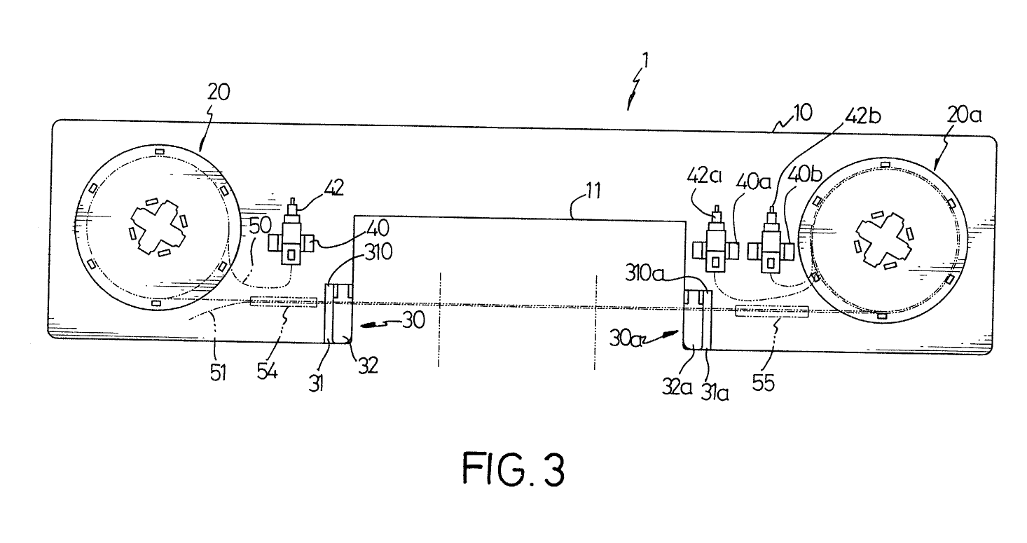

Referring to FIG. 3, in manufacturing of a coupler for optical fibers, two optical fibers (50, 51) are fastened on the fixing carrier (1). The first optical fiber (50) with a predetermined length is secured by the clamps (30, 30a). Sheathes of two ends of the first optical fiber (50) and of a middle part between the clamps (30, 30a) are stripped off. The first end of the first optical fiber (50) is rolled over the first reel (20) and inserted into the first adapter (42). The second end of the first optical fiber (50) is rolled over the second reel (20a) and inserted into the second adapter (42a).

The second optical fiber (51) is fastened by the clamps (30, 30a). A first end of the second optical fiber (51) extends over the first clamp (30), and a sheath of a middle part of the second optical fiber (51) between the clamps (30, 30a) is also stripped off. A second end of the second optical fiber (52), of which a sheath is stripped off, is rolled over the second reel (20a) and inserted into the third adapter (40b).

A sleeve (54), through which the first ends of the optical fibers (50, 51) are inserted, is provided between the first reel (20) and the first clamp (30), and a tube (55), through which the second ends of the optical fibers (50, 51) are inserted, is provided between the second reel (20a) and the second clamp (30a).

The fixing carrier (1) on which optical fibers (50, 51) are fastened can be transferred to a production-line including sintering station, sleeve-encapsulating station, tube-encapsulating station, testing station and packing station for further processes of manufacturing a coupler.

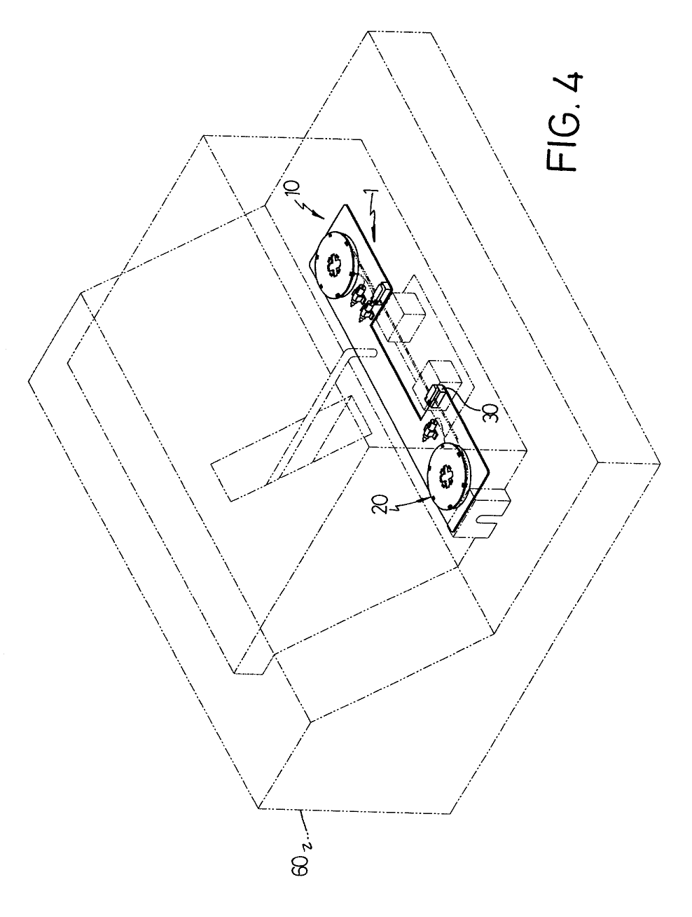

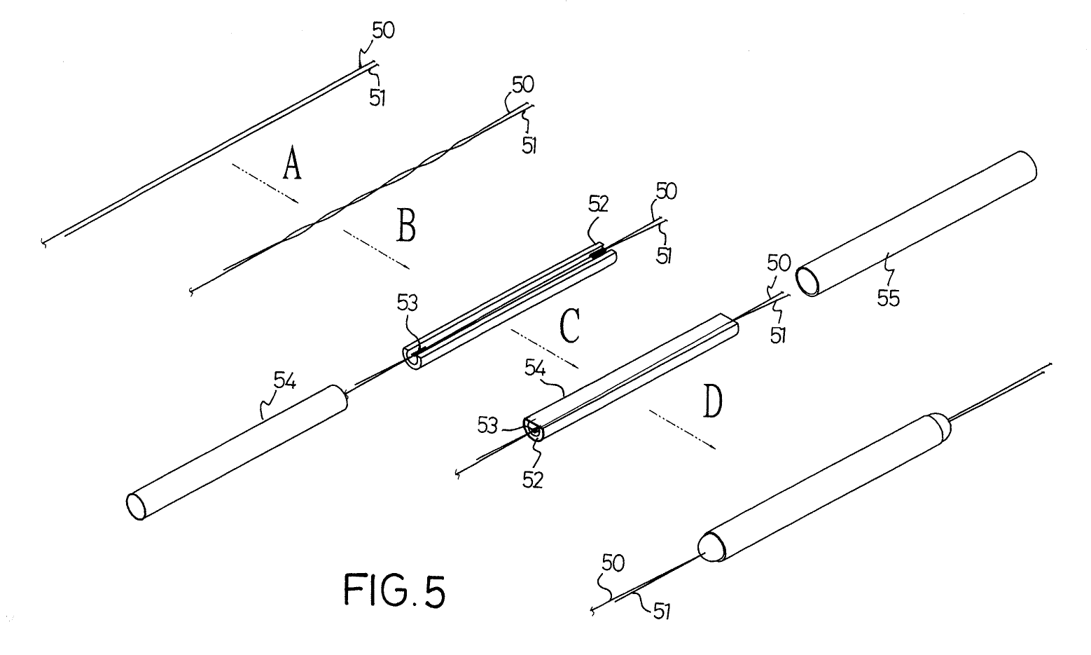

FIG. 4 shows the fixing carrier (1) placed on a work table (60) for sintering. In processing, the optical fiber adapters (42, 42a, 42b) are connected with light sources and interconnecting devices. Referring to FIG. 5, the clamping sheets (32, 32a) are pivoted upwards to release the optical fibers (50, 51), and the optical fibers (50, 51) are treated with a process of knotting (A). The knotted optical fibers (50, 51) are sintered on the work table (60). In a step of pre-encapsulating (B), the sintered optical fibers (50, 51) are—covered with a glass tube (52) of which a cross section is U-shaped and adhered with the glass tube (52) by glue (53) at two ends of the glass tube (52). Whereafter, the optical fibers (50, 51) are fastened by the clamps (30, 30a) again, and the carrier (1) is transferred to a work station for sleeve-encapsulating (C), and another work station for tube-encapsulating (D). Because the sleeve (54) and the tube (55) have been provided on the optical fibers (50, 51), the encapsulating processes can be finished quickly.

After encapsulating processes, the reels (20, 20a) are detached from the plate (10). The semi-manufactured product and the reels (20, 20a) are transferred to remaining work stations. The plate (10) and the optical fiber adapters (42, 42a, 42c) can be reused.

According to the present invention, the sheathes are stripped off before the optical fibers are transferred to work stations. Workers for knotting, sintering, encapsulating can directly and continuously process the optical fibers, so that a lot of time is saved and a work efficiency of machines is high.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fixing carrier for manufacturing a coupler for optical fibers, the fixing carrier (1) comprising:
a plate (10);
two reels (20, 20a) for rolling optical fibers, the reels (20, 20a) detachably mounted at two ends of the plate (10) respectively;
two clamps (30, 30a) for fastening optical fibers, the clamps (30, 30a) mounted on the plate (10) and adjacent the reels (20, 20a) respectively;
a plurality of seats (40, 40a, 40b) mounted on the plate (10), and adjacent the first reel (20) and the second reel (20a) respectively; and
a plurality of optical fiber adapters (42, 42a, 42b) mounted in the seats (40, 40a, 40b) respectively.

2. The fixing carrier (1) as claimed in claim 1, wherein the plate (10) has two holes (12) in alignment with the reels (20, 20a) respectively, and the reels (20, 20a) each comprise:
a bottom ring (21) of which an inner diameter is larger than a diameter of the hole (12), the bottom ring (21) having a plurality of notches (211) and protrusions (212) alternately and evenly formed on an upper edge of the bottom ring (21);
an inner disk (22) of which an outer diameter is larger than the diameter of the hole (12), the inner disk (22) having an inner ring (220) formed adjacent an outer edge thereof and extending through the hole (12) from a bottom of the plate (10), an aperture (221) defined through a central portion thereof, and a plurality of barbs (222) formed around the aperture (221) and extending upwards; and
an upper cover (23) having an upper ring (230) formed on a bottom surface thereof and engaged with the inner ring (220), a plurality of first slots (231) circumferentially defined adjacent an outer edge of the upper cover (23) for receiving the protrusions (212) respectively, and a plurality of second slots (232) defined at a central portion of the upper cover (23) for receiving the barbs (222) respectively.

3. The fixing carrier as claimed in claim 1, wherein the clamps (30, 30a) each have a base (31, 31a) and a clamping sheet (32, 32a) pivotally mounted on an upper surface (310, 310a) of the base (31, 31a).

4. The fixing carrier as claimed in claim 1 comprising at least three seats (40, 40a, 40b) mounted on the plate (10), wherein at least one seat (40) is provided adjacent the first reel (20), and at least two seats (40a, 40b) are provided adjacent the second reel (20a).

5. The fixing carrier as claimed in claim 1, wherein the plate (10) has an opening (11) defined at a central portion thereof, and the clamps (30, 30a) are respectively provided at two sides of the opening (11).
